(19) United States
(12) Patent Application Publication
(10) Pub. No.: US 2026/0181195 A1
(43) Pub. Date: Jun. 25, 2026

(54) A method of generating video content

(71) Applicant: Flok Health Ltd, Cambridge (GB)

(72) Inventors: Finn Cameron James Stevenson; Ricardo Michael Henderson Da Silva

(21) Appl. No.: 19/142,602

(22) PCT Filed: Dec. 22, 2023
(86) PCT No.: PCT/GB2023/053360

§ 371 Date: Jun. 23, 2025

(30) Foreign Application Priority Data
Dec. 23, 2022 (GB) 2219760.2

(51) Int. Cl. H04N 21/234; H04N 21/258; H04N 21/422; H04N 21/442

(52) U.S. Cl. CPC H04N 21/23424; H04N 21/25866; H04N 21/42203; H04N 21/44218

(57) ABSTRACT

A method of generating and playing out video content. The method comprising receiving one or more characteristics of a viewer, selecting a plurality of video clips by sampling a library of pre-generated video clips based on the one or more characteristics, and generating a personalised video stream by populating a scripted template with the selected plurality of video clips. The method comprises sampling the library of pre-generated video clips one or more further times during the generating of the personalised video stream based on viewer feedback.

### FIELD OF THE INVENTION

This invention relates to producing customised video content for consumption by multiple viewers.

### BACKGROUND

Entertainment, communications, and audience interaction are increasingly facilitated by live video. For example, it is now possible to consult a doctor or participate in a fitness class or educational class via a live video feed.

However, a live video stream inherently has a limited audience. The video content is not interactive, so viewers must watch a different stream if they want to see different content. Video content for one-to-one audiences, such as doctors' appointments and telehealth are difficult to scale without spiralling costs, resource requirements and time constraints.

Alternatively, pre-recorded content libraries are hard to make interactive & engaging, and often viewers will lose interest. This is particularly the case for educational, fitness, and medical content as each has a degree of difficulty associated with it. The digital fitness model for creating one-to-many live stream content can be engaging. However, such content cannot be easily used for medical applications where content requirements depend on the specific needs of the viewer. A single scripted fitness class may not be the best version of itself for all those watching.

Methods exist for inserting individualised advertisements into broadcast streams. However, this is typically a mixture of purely pre-recorded content where merely the combination of adverts are personalised and not the consumable content.

It is desirable to develop a method to create mixtures of customised and pre-generated content which are capable of being interactive and customisable to the viewer.

### SUMMARY OF THE INVENTION

According to one aspect there is provided a method of generating and playing out video content, the method comprising: receiving one or more characteristics of a viewer; selecting a plurality of video clips by sampling a library of pre-generated video clips based on the one or more characteristics; and generating a personalised video stream by populating a scripted template with the selected plurality of video clips, wherein the method comprises sampling the library of pre-generated video clips one or more further times during the generating of the personalised video stream based on viewer feedback.

According to another aspect there is provided a method of generating and playing out video content, the method comprising: receiving one or more characteristics of a viewer; selecting a plurality of video clips by sampling a library of pre-generated video clips based on the one or more characteristics; and generating a personalised video stream by populating a live scripted template with the selected plurality of video clips.

The characteristics of the viewer may comprise a medical condition or ailment.

The pre-generated video clips may be one or more of instructional videos comprising one or more tasks to be performed by the viewer or educational videos.

The viewer feedback may indicate a level of difficulty of the one or more tasks in one or more of the selected video clips already viewed. The viewer feedback may comprise rating on a scale the difficulty of the one or more tasks in one or more of the selected video clips already viewed. The viewer feedback may comprise detecting via a camera directed at the viewer that the viewer is unstable whilst performing one or more of the tasks in one or more of the selected video clips.

The viewer feedback may comprise detecting via a microphone of a device in the vicinity of the viewer that the viewer is in pain or struggling whilst performing one or more of the tasks in one or more of the selected video clips.

The scripted template may comprise multiple content forks populated by alternative video clips in anticipation of one of a plurality of possible viewer feedback options.

The tasks may be any combination of one or more of stretches, exercises, or yoga poses.

The characteristics of a viewer may comprise any one or more of age, sex, weight, height, fitness level, pre-existing health condition, blood sugar level, stage of treatment.

The method may comprise arranging the selected plurality of video clips into one or more groups prior to populating the scripted template based on one or more viewer characteristics.

The scripted template may be captured live and populated in during playout of the personalised video stream to the viewer. The scripted template may be a pre-generated video and populated during playout of the personalised video stream to the viewer. The scripted template may be populated based on viewer feedback. The scripted template may comprise a live host.

The personalised video stream may be transmitted to multiple viewers having the same characteristics.

The method may comprise capturing the live scripted template comprising a host in front of a background replacement screen, and where the scripted template is dimensioned such that one or more of the pre-generated video clips may be inserted in place of the background replacement screen to give the impression that the host is present within the same three-dimensional physical space as a subject of the one or more pre-generated video clips.

The method may comprise: capturing the scripted template comprising a host in front of a background replacement screen; recording the pre-generated video clips in front of a background replacement screen; and overlaying both the scripted template and pre-generated video clips on a common background in place of the background replacement screen and dimensioned to give the impression that the host and the subject of the one or more pre-generated video clips are present within the same three-dimensional physical space.

The scripted template may comprise portions where the host cannot be seen to allow for insertion of one or more of the pre-generated video clips which comprise panning shots or zoomed perspectives.

The pre-generated video clips and scripted template may have complimentary production parameters such as sound level, aspect ratio, lighting level, lighting direction.

The pre-generated video clips and scripted template may be produced with flat lighting.

The pre-generated video clips may comprise a difficulty rating and the pre-generated video clips are selected from the video library based on their assigned difficulty rating and how many personalised video streams a viewer has previously viewed in relation to their condition or ailment.

The method may comprise post-generation processing of the personalised video stream to alter the production parameters of the scripted template or the selected video clips or both to match the production parameters of a common background.

The pre-generated video clips may have multiple audio tracks selectable depending on viewer characteristics.

The viewer characteristics may comprise one or more of how many personalised video streams that viewer has previously viewed containing the same video clip, the viewer's nationality, the viewer's chosen language.

The method may comprise generating additional frames for insertion between pre-generated video clips to smooth scene transitions within the generated personalised video stream.

According to another aspect there is provided a method for providing customised content to viewers, comprising: receiving viewer information specific to each of a plurality of viewers; storing a series of content elements, each content element being a video clip or a definition thereof; assigning one or more of a plurality of content type categories to each of the content elements; defining a program schedule comprising a series of content type categories; capturing by means of a video camera an input video stream; and executing program code on one more processors to select, for each of the viewers, a series of content elements of the categories defined in the program schedule, the content elements being selected in dependence on the viewer information of the respective viewer; and to form for each of the viewers an output video stream by combining the input video stream with the selected series of content elements.

The program schedule may define a time for each of the content type categories of the series, and the method comprises executing the program code to combine the input video stream with content elements of the respective categories at the respective times.

The steps of selecting and forming may be performed contemporaneously with the step of capturing.

The video stream may comprise video of a presenter introducing content elements of the program schedule.

At least one of the content elements may be a definition of a video clip, and the method comprises executing the program code to venerate the video clip according to the definition.

According to another aspect there is provided a video creation system for forming a plurality of custom video feeds by combining one or more pre-stored video elements with a primary video feed, the system comprising: a memory storing the pre-stored video elements; a fanout server arranged to receive the primary video feed and replicate the primary video feed to form a plurality of secondary video feeds; and a plurality of mixers, arranged to receive a respective one of the secondary video streams, determine a plurality of combinations of that secondary video stream with selected ones of the pre-stored video elements, implement each of those combinations by combining the secondary stream with the selected pre-stored elements to form a respective output stream, and output the output streams for playout by viewers. Each mixer may be implemented by software executed by one or more processors. Each fanout server may be implemented by dedicated hardware.

According to another aspect there is provided a video creation system as claimed in any preceding claim, wherein the system is capable of receiving requests from viewers to view an output stream and the system comprises a management entity, the management entity being configured to: determine the number of requests for output streams; in dependence on that determination determine a number of mixers; and in dependence on the determined number of mixers, instantiate or terminate one or more instances of the mixers.

### BRIEF DESCRIPTION OF THE FIGURES

The present invention will now be described by way of example with reference to the accompanying drawings. In the drawings:

FIG. 1a shows an example scripted template.

FIG. 1b shows an example of a plurality of pre-generated video clips being selected to populate an example scripted template.

FIG. 2 shows a schematic diagram of a system and components required to produce a personalised video stream.

FIG. 3 shows an example frame of a personalised video stream comprising the scripted template with host and pre-generated video clip both with a common background.

FIG. 4 shows a flow diagram of the proposed method of generating video content.

### DETAILED DESCRIPTION OF THE INVENTION

In the wake of the Covid outbreak many people have become accustomed to consulting with doctors and other health professionals via video calls. These live consultations are capable of providing high quality remote care. However, delivering one-to-one care in this manner does not scale to adequately address common health conditions where optimal clinical outcomes are dependent on patients receiving fast and frequent access to multidisciplinary care. For quality of life limiting conditions like back pain, it is considered clinically important that patients receive fast access to a programme of non-invasive therapy that includes a mix of physical interventions (such as physiotherapy exercises, pilates, and assorted movements to improve strength, mobility, and balance) and psychosocial interventions (for example pain management education, behavioural change coaching, and wellbeing techniques such as breath work and mindfulness). It is also important that patients are encouraged to regularly engage with these therapies over a prolonged period of time to maximise effectiveness. While many patients with a shared clinical condition will have overlapping needs, their precise clinical requirements will vary in important ways. Examples might include differing prior and current levels of mobility, differing response rates to treatment, a differing timeline of symptom presentation, different risk profiles for their pain becoming chronic, and varying ability to perform interventions with differing difficulty levels. In addition to different initial clinical needs, patients also benefit from monitoring and adjustment of their programme as they progress through treatment to account for changes in their condition or response. Providing immediate and ongoing access to gold-standard care of this nature is very time consuming for healthcare professionals, and is therefore generally limited to settings with significant resource availability per patient, for example athletes in elite sports teams. Delivering this same quality of care at scale for members of the general population would have significant benefits for the individuals concerned as well as society more broadly, however doing so is not practical within current delivery models.

There is proposed herein a method for producing an arbitrary number of video streams which combine a scripted template stream input with a plurality of pre-generated input clips such that each output stream contains content appropriate for a specific viewer or set of viewers. The scripted template stream may be a live stream. In this way, for example, a tailored physiotherapy session can be provided, comprising a host or guide, while containing pre-generated exercises or stretches specifically selected for the viewer concerned. If multiple viewers require the same combination of stretches or exercises then the same stream may be sent to multiple viewers.

The proposed method of generating video content comprises receiving one or more characteristics of a viewer; selecting a plurality of video clips by sampling a library of pre-generated video clips based on the one or more characteristics; and generating a personalised video stream by populating a scripted template with the selected plurality of video clips. The proposed method may comprise sampling the library of pre-generated video clips one or more further times during the generating of the personalised video stream based on viewer feedback. The scripted template may be a live video stream. The generated personalised video stream may be used to provide a multidisciplinary treatment session.

The proposed method of combining different types of content into a stream to generate a personalised and hybrid content type for consumption by specific viewers is not limited to provision of physiotherapy instruction. It should be understood that such a method could also be applied to any content production whereby a scripted template and pre-generated content are desired to be combined by populating the scripted content in a personalised manner. The description of the proposed method in the context of providing a personalised routine is merely provided as an example context for implementation of the proposed method.

Further to the above-described method, pre-generated content inputs may be reconfigured or redirected in response to real-time viewer interactions. For example, if a viewer indicates in some way that the current exercise or move is too difficult, later exercises in the selected video clips to be shown may be altered. This approach can be used to addresses two challenges of the one-to-many model for diverse viewer needs. Firstly, the simultaneous generation of many video streams—as so long as the plurality of viewers have the same complaint, they can all benefit from the same stream. Secondly, choosing the appropriate content—individual feedback can further indicate which of the pre-generated video clips yet to be shown may or may not be appropriate for one or more viewers.

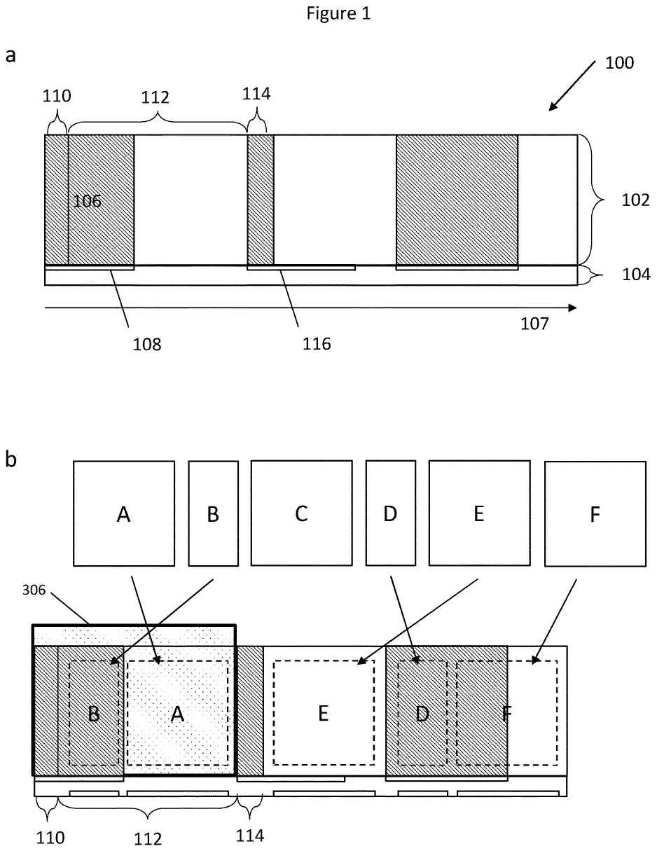

FIG. 1a shows an example scripted template 100. As described above, a key feature of the proposed method is populating the scripted template. The scripted template includes a plurality of sections. The sections may comprise one or more scripted content sections only for scripted content to be provided by a host, a plurality of content sections, placeholders, or slots to be populated by only pre-generated video clips, and some sections where both types of content may be shown concurrently. The scripted template and pre-generated content may be only video content, only audio content, or both video and audio content provided simultaneously. The example scripted template of FIG. 1a is illustrated as though displayed from left to right along timeline 101.

The example scripted template has been divided into a video section 102 and an audio section 104 to illustrate when the host of the scripted template 100 is visible, or audible, or both. This divide may not be a visible or a physical feature of the scripted template and may be shown here for illustrative purposes only.

The example scripted template 100 comprises diagonally striped video portion 106 with accompanying audio 108 which is indicated as running concurrently in the audio section 104 underneath. Portion 106 indicates where in the scripted template the content is visible.

The initial portion 110 indicates a portion of the scripted template where only the scripted content is visible and audible. For example, a host of the content may provide an introduction here, and none of the pre-generated video clips may be allowed to be displayed during this time.

Portion 112 of the scripted template indicates a portion which may be populated by one or more of the selected pre-generated video clips and accompanying audio. A further portion 114 may be configured to exclusively allow for the scripted template content to be visible. For example, a host may use this portion to segway into the next segment of the personalised video stream which will concentrate on a different type or set of pre-generated video clip content. The scripted template may comprise a live video stream with a live host. Note that the audio 116 associated with portion 114 continues after the visual component of portion 114 ends. In some instances this may be due to the visual content of the pre-generated video clip populating the next section not allowing for other visual content to be displayed. For example, the live scripted template comprises portions where the host cannot be seen to allow for insertion of one or more of the pre-generated video clips which comprise panning shots or zoomed perspectives. The timing of when the host is visible or audible may depend on the selected pre-generated video clips. Conversely, the scripted template may simply include an indication to the host that they can't be seen while the current pre-generated video clip is playing out and the template will therefore not display the host.

Indications may be provided to the host while capturing the scripted content. The host may be instructed as part of the scripted template of when they can and cannot be seen or heard and where they should stand. The scripted template may be adapted based on the selected pre-generated content such that when close-up shots or audio of the pre-generated video clips are being played out to the viewer, the host knows not to make any reference to their movements or to speak.

FIG. 1b shows an example of a plurality of pre-generated video clips being selected to populate an example scripted template. Another key feature of the proposed method is a library of pre-generated video clips. The library may comprise a catalogued repository of pre-generated video clips or segments. The video clips may comprise recorded live action or generated CGI content or a combination of both. FIG. 1b shows an example library of pre-generated video clips A-F.

Each pre-generated video clip A-F may be made up of one or more frames of content. The content may be demonstrating one or more of tasks, educational information, counselling content, and/or behavioural change advice. The pre-generated video clips may be educational videos to be consumed by the viewer. The pre-generated video clips may be instructional videos which, for example, comprises one or more tasks to be performed by the viewer. The one or more tasks may comprise any combination of actions to be carried out, for example stretches, exercises, or yoga poses. That is to say one pre-generated video clip may comprise one frame of video, or one task comprising multiple frames of video, or multiple tasks each comprising either one or multiple frames of video. The content of the pre-generated video clips will be described herein in terms of physical tasks as an example only. It should be understood that the process of producing the personalised video stream can comprise video clips containing any combination of tasks, educational information, counselling content, and behavioural change advice.

The content of the pre-generated video clips may cover a broad subject range of tasks. For example, strengthening exercises, breathing exercises, cardiovascular exercise, proprioception exercises, Pilates based rehabilitation, physiotherapy, psychological techniques including mindfulness and pain management techniques.

Some video clip content may comprise details for tasks that may not be performed at the time of viewing, but where the tasks will be advised for carrying out later in the day or as part of the viewer's daily routine. Examples may include: how to effectively use superficial hot and cold modalities like heat/ice packs, advice to perform specific exercises at other points in the day, e.g. Kegels at red traffic lights, or touching your toes when you get out of bed.

FIG. 1b also shows a selection of the pre-generated video clips A-F being used to populate the example scripted template shown in FIG. 1a. Clips A-F may be categorised to assist in their selection and placing within the scripted template so that the desired type of personalised video stream can be easily and accurately created.

The library or catalogue of pre-generated video clips may organise and store clips to be retrieved according to an algorithm comprising certain required classifications. Each of the pre-generated video clips may be marked to indicate these classifications by metadata. The metadata may include classification axes comparing multiple traits. For example, for physiotherapy videos the classifications could include any one or more of the following:

The level of difficulty or suitability or physical ability level required to perform or complete the demonstrated task adequately. For example, the pre-generated video clips comprise a difficulty rating and the pre-generated video clips are selected from the video library based on their assigned difficulty rating and how many personalised video streams a viewer has previously viewed in relation to their condition or ailment.

The relationship with other pre-generated video clips. For example, clip D must be preceded by clip A, or clip A is more effective if it's followed by clip E.

The treatment stage appropriateness. That is, when during a treatment plan the particular task in a video clip is applicable or useful. For, example, very easy stretches may not be appropriate in later stages of treatment when the viewer is fitter or stronger, similarly very difficult stretches may not be appropriate for early stages of treatment.

The modality of the of the pre-generated video clip content. That is, what type of task the clip is directed to. For example, physical, mental, etc.

The production parameters of the pre-generated video clip. If a portion of the scripted template is not suitable for pre-generated video clips with certain production parameters, then clips marked with those parameters may not be selected to populate that portion of the template. Such production parameters may comprise viewing angle, lighting level or direction, zoom percentage, panning, sound level, aspect ratio, etc. Thus, the pre-generated video clips may be selected such that the pre-generated video clips and scripted template have complimentary production parameters such as sound level, aspect ratio, lighting level, lighting direction.

Another metric may be any user engagement metrics associated with that pre-generated video clip. For example, effectiveness, drop-off rate, user engagement success rate, etc.

Selection of pre-generated video clips from the library is based on one or more characteristics of a viewer. The characteristics of the viewer may comprise a medical condition or ailment. The characteristics may also comprise any one or more of age, sex, weight, height, fitness level, pre-existing health condition, blood sugar level, stage of treatment, etc. The viewer characteristics may also include the viewer's response to the instructional content. That is, for example, whether the viewer's condition is improving and at what rate, etc. The viewer characteristics may include information about that viewer's participation in an assigned course or program. For example, the viewer characteristics may include when a viewer has missed one or more personalised video streams in a series of video streams. The personalised video stream may be part of a scheduled programme of content which may be one or more of generated at particular times, for viewing at particular times, viewing at particular intervals, or viewing within particular windows of time. The viewer characteristics may also be updated based on received viewer feedback. That is, viewer feedback may provide information which can be used to assign an additional viewer characteristic. This may be in response to a prompt (e.g. a direct question) or self-reported (e.g. a statement that they are anxious). Viewer feedback will be discussed in more detail below.

Each viewer can be defined by a series of characteristics collected before video content production. The characteristics are used to sample the wide variety of pre-generated video clips in the library down to a number selected as specifically relevant to the viewer and their requirements. These selected pre-generated video clips can then be selected from to populate the scripted template. All of the selected pre-generated video clips need not be used in a single personalised video stream. The method may comprise arranging the selected plurality of video clips into one or more groups prior to populating the scripted template based on one or more viewer characteristics.

Referring back to FIG. 1b, it can be seen that clips A and B have been selected to populate section 112 of the scripted template. While clip B is visible so is the host or other visual of the template. The audio from both the template and clip B can be heard simultaneously, though they are not necessarily interfering with each other. None of the video clips are able to populate sections 110 or 114. Video clips E, D, and F have been used to populate the rest of the example scripted template. Clip D is played out before clip F in this example. As a result, the host or visuals of the scripted template are visible during the playing out of all of clip D but only half of clip F. Clip D may have been specifically selected to be shown at the start of this portion of the scripted template instead of clip F. For example, this may be because the second half of clip F comprises zoomed in portions which would not cooperate with the visuals of this section of the scripted template.

The proposed system therefore generates a personalised video stream for each viewer based on their characteristics by combining a video stream with the selected pre-generated clip sequence according to the scripted template. The video stream may be integral to the scripted template. The video stream or scripted template may be a live stream. The same personalised video stream may be transmitted to multiple viewers having the same characteristics. For example, viewers of the same age, with the same condition, and at the same stage of treatment may be provided with the same personalised video stream based on these characteristics. That is, the personalised video stream may be transmitted to multiple viewers having the same characteristics, or substantially similar characteristics, such that it can be determined that those viewer's would benefit from the same personalised video stream. Viewer feedback may also be used to determine or change which personalised video stream is delivered to which viewer.

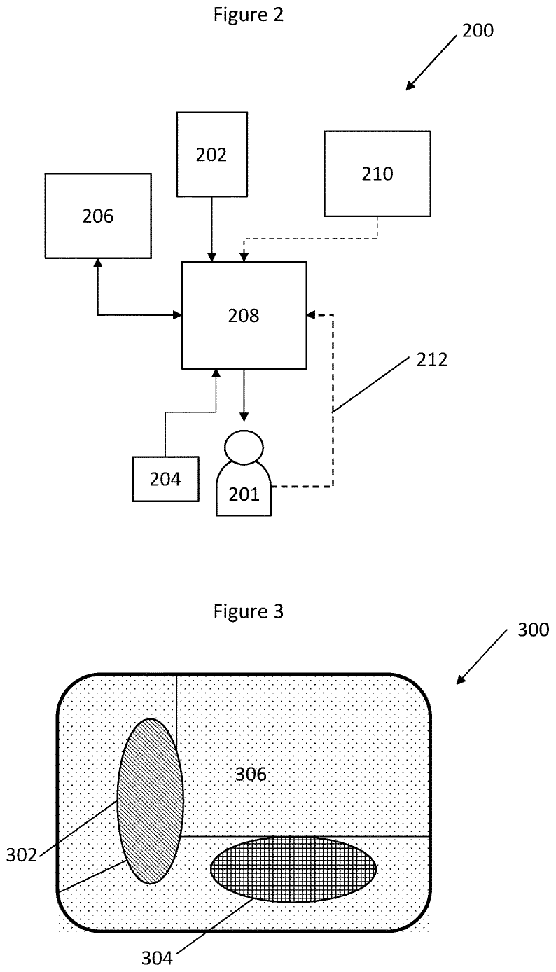

FIG. 2 shows a schematic diagram of a system 200 and components required to produce a personalised video stream. Viewer characteristics 204 are provided to the controller 208 of the system 200. The viewer 201 may directly provide these characteristics on request. For example, by selecting options from one or more lists presented to them. The characteristics 204 may be delivered to the system as part of a user profile. The viewer 201 may not be the only person with access, or capable of supplying information for the profile. For example, a medical professional may provide information for the user profile indicating for which medical condition the viewer requires treatment. That is, the condition a viewer is seeking to obtain help with via the personalised video stream is provided to the system as part of the viewer characteristics. Viewer characteristics may also be determined algorithmically based on patient interactions with the system.

Controller 208 may then query the library 206 of pre-generated video clips based on the one or more characteristics 204. Pre-generated video clips which are determined to be suitable according to the one or more viewer characteristics provided are then returned to the controller 208. The returned selected pre-generated video clips may then be used to populate a scripted template 202. The scripted template may be one of multiple available scripted templates 202. The selection of which template to use may be based on the provided viewer characteristics 204.

The proposed method may comprise a viewer feedback mechanism 212 such that the pre-generated sequence yet to be watched for each viewer can be adjusted as they watch and interact with the content. One way to achieve this may be to replace the pre-generated video clips already populating the scripted template after the current point of viewing by the viewer based on real-time viewer feedback.

Alternatively, the scripted template may comprise one or more forks. A different selection or order of pre-generated video clips may be selected to populate the respective forks in the playback timeline. Which fork is subsequently played out to the viewer will then depend on the received viewer feedback prior to the forking point in the scripted template.

Therefore, the proposed method may comprise sampling the library of pre-generated video clips one or more further times during the generating of the personalised video stream based on viewer feedback. Alternatively or additionally, the scripted template may comprise multiple content forks populated by alternative or differently arranged video clips in anticipation of one of a plurality of possible viewer feedback options.

The viewer feedback 212 may comprise a plurality of user input options and methods of collection. For example, the viewer feedback may indicate a level of difficulty of the one or more tasks in one or more of the selected video clips already viewed. Similarly, the viewer feedback may indicate a level of difficulty of the one or more tasks in one or more of the selected video clips currently being viewed. One or more of various indications of difficulty may be provided by the viewer actively by engaging with the system directly or passively by observations or detections by the system of the viewer's state. For example, the difficulty level may be based on any combination of perceived pain level, self-reported emotional state (e.g. anxiety level), intensity, fatigue, understanding—e.g. response to questions like “does that make sense?” or “Do you need more help with this movement yes or no?”, preference—e.g. a response to questions like “did you prefer X or Y?”, ability to do something—e.g. a response to questions like “are you able to do this or not?”. Based on this indication other an alternative scaled version of the content may be provided in its place in future video streams. Additionally or alternatively, responses may not part of a fixed set. For example, the viewer could be asked an open question with the option of providing a free text response. The system may record and/or analyse those responses. The free responses may also be given verbally by the viewer.

The viewer feedback may comprise directly provided rating on a scale the difficulty of the one or more tasks in one or more of the selected video clips. For example, the rating may comprise selecting a numerical value within a range, e.g. from 1 to 10 or 1 to 5, etc. Selecting a number of stars or other icons in a range, e.g. from 1 to 10 or 1 to 5 etc. Alternatively, the rating may comprise selecting a word from multiple words which indicates the difficulty or level of satisfaction with one or more of the pre-generated video clip content.

Viewer feedback may comprise observations about the viewer whilst watching the selected pre-generated video clips. For example, the viewer feedback may comprise detecting via a camera directed at the viewer that the viewer is unstable whilst performing one or more of the tasks in one or more of the selected video clips. The viewer feedback may comprise detecting via a microphone of a device in the vicinity of the viewer that the viewer is in pain or struggling whilst performing one or more of the tasks in one or more of the selected video clips. Similarly, the viewer feedback may comprise detecting that the viewer is simply not engaging at all with the instructed task of the pre-generated video clip. Other indications which could be decerned from a camera may comprise any combination of: looking at the range of motion of the viewer to measure progression and severity; estimate or measure body habitus, weight, anthropometrics; indicators of effort such as facial expression, respiratory rate, heart rate, surface body temperature, shaking or tremors; noting when a viewer is leaving a pose or position to take a break. Other devices may be used to monitor these aspects and traits of the viewer. For example, a wearable device, a non-wearable piece of accessory hardware—e.g. exercise mat instrumented with sensors. Other sensors may also be used to measure some of the above-mentioned traits. For example, infrared sensors may be used to measure body surface temperature. Any physical device that connects to the system may be equipped with any set or combination of sensors for the purposes of measuring any combination of the above described viewer feedback options.

Additionally or alternatively, some viewer feedback may instigate additional viewer characteristics. These characteristics may be directly provided by the viewer or inferred from the feedback provided. Therefore, some responses or observed traits during a class might be assigned to a viewer as characteristics and remain associated with the viewer going forwards.

In some embodiments a background 210 may be provided. In some instances the scripted template and pre-generated video clips may be captured in front of a green screen or other background replacement screen for background replacement or subject isolation video post processing. The controller 208 may be configured to select a background from multiple available backgrounds for inserting into the frames of the personalised video stream in place of the background replacement screen area. In doing so the host and the subject of the pre-generated video clip may appear to be located in the same location as shown in the selected background. For example, the background may be any one of a beach, an exercise studio, a living room, a garden, etc. Alternatively, the background may be selected by the viewer via the viewer feedback or based on a viewer characteristic.

The above described plurality of pre-generated video clips in the library 206, plurality of available scripted templates 202, and plurality of backgrounds 210 may be stored in a dedicated or shared memory. The memory may be part of the system and accessible to the controller 208. The memory may be internal to the controller. The memory may be remotely located and accessible by the system and/or controller on request.

The generated personalised video stream is then output to the viewer 201. The personalised video stream may be transmitted to multiple viewers having the same characteristics. In this way the scalability of providing healthcare to multiple viewers is improved as a one-to-many approach may be used while still allowing for creation of directed content for a specific audience. The viewers may also then be able to further customise the generated stream by providing individual feedback. Due to limited options for the different feedback outcomes, the consequences of altering the personalised video stream in response to feedback is still likely to mean the resulting stream post alterations will be applicable to multiple viewers.

FIG. 3 shows an example frame 300 of a personalised video stream comprising a scripted template with host 302 and a pre-generated video clip 304. The background of the frame may be the background of the pre-generated video clip or the scripted template, or as mentioned above a separate common background 306 may be used as shown in FIG. 3. In the example frame as area shows part of the pre-generated video clip 304. For example, this part of the frame may show a person lying on an exercise mat demonstrating a yoga pose. The area showing part of the scripted template 302 may display a host standing facing the camera or the model and describing the task, or providing supplementary educational information and/or advice. For example, teaching a viewer about spinal anatomy while they are engaged in holding a stretch.

The proposed method may comprise capturing the scripted template comprising a host in front of a background replacement screen. The proposed method may comprise capturing the scripted template comprising a host using a subject or foreground isolation technique. The scripted template may be dimensioned such that one or more of the pre-generated video clips may be inserted in place of the background to give the impression that the host is present within the same three-dimensional physical space as a subject of the one or more pre-generated video clips.

As mentioned above, the method may comprise capturing the scripted template comprising a host in front of a background replacement screen and recording the pre-generated video clips in front of a background replacement screen. The method may then comprise overlaying both the scripted template and pre-generated video clips on a common background in place of the background replacement screen. Where the scripted template, pre-generated video clip and background are dimensioned to give the impression that the host and the subject of the one or more pre-generated video clips are present within the same three-dimensional physical space.

The pre-generated video clips and scripted template may be produced with flat lighting. This may allow for artificial lighting to be added in post-generation processing or postproduction of the generated personalised video stream such that the host and the subject of the one or more pre-generated video clips appear to be present within the same three-dimensional physical space.

Similarly, the method may comprise post-generation processing of the personalised video stream to alter the production parameters of the scripted template or the selected video clips or both to match the production parameters of a common background.

For example, if the background 306 is of a sunset, the lighting colour values and direction and severity of shadows cast may be changed or added artificially such that the pre-generated video clip, or the host of the scripted template, or both, appear to be located physically within the same environment as the sunset background. Referring back to FIG. 1b, an example common background 306 is shown behind the scripted template section 110 and pre-generated video clip section 112.

Other possible production parameters may include technical video and audio parameters such as those mentioned above: viewing angle, lighting level or direction, zoom percentage, panning, sound level, aspect ratio, etc.

As mentioned above, the pre-generated video clips may have an audio track. The pre-generated video clips may have multiple audio tracks selectable depending on viewer characteristics. In this case the viewer characteristics may additionally comprise one or more of how many personalised video streams that viewer has previously viewed containing the same video clip, the viewer's nationality, the viewer's chosen language. For example, the initial audio track may be one explaining in detail how to do a particular stretch when viewed the first time. However, an alternative audio track may be selected when the clip is viewed subsequent times which simply says the name of the stretch, gives brief reminders of the main points for executing the stretch well, or is silent and allows for the audio of the scripted template to be heard instead. Additionally or alternatively, an audio background or soundscape may be selected and added to the personalised video stream. The audio background may or may not be matched to a specific visual background.

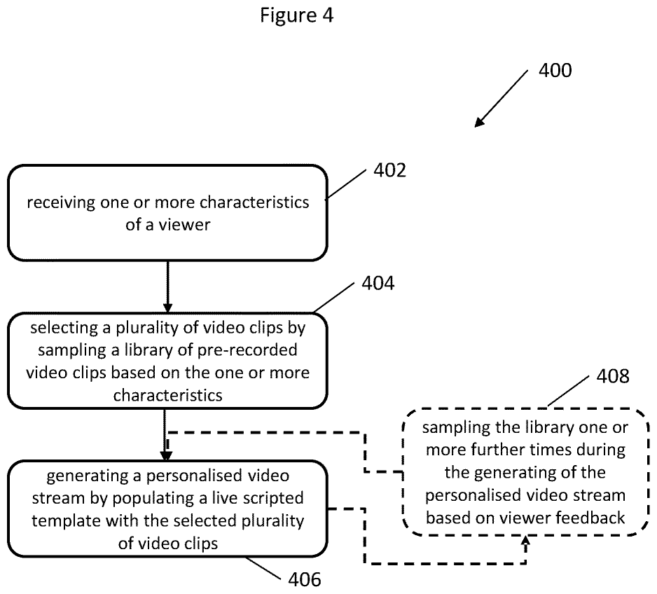

FIG. 4 shows a flow diagram of the proposed method 400 of generating video content. More specifically, the method of generating a personalised video stream. At step 402 one or more characteristics of a viewer are received. As mentioned above, the one or more characteristics may be provided by the viewer themselves, an associated professional such as a medical practitioner, or a combination of the two.

At step 404 the proposed method comprises selecting a plurality of video clips by sampling a library of pre-generated video clips based on the one or more characteristics. For example, as described above, the library of pre-generated video clips comprises a plurality of pre-generated clips which may be grouped according to content type or another such viewer characteristic and then selected from based on those characteristics. These clips may be further categorised based on difficulty etc. and selected based thereon as a result of other viewer characteristics likes stage of treatment etc.

At step 406 the method generates a personalised video stream by populating a scripted template with the selected plurality of video clips. The scripted template content may be captured live. The scripted template content may be populated during playout of the personalised video stream to the viewer. The scripted template may be captured live and populated during playout of the personalised video stream to the viewer. The scripted template may be captured live or be pre-recorded and sections or gaps in the video and audio may be filled with already selected pre-generated video clips as required. That is, the order of the pre-generated video clips may be selected in advance of populating the scripted template. Alternatively, the scripted template may be populated by pre-generated video clips from a selected group ad hoc as the playout of the generated personalised video stream is viewed. The proposed method may comprise generating additional frames for insertion between pre-generated video clips to smooth scene transitions within the generated personalised video stream.

At step 408 the method may comprise sampling the library one or more further times during the generating of the personalised video stream based on viewer feedback. As described above, a viewer may provide feedback to the system 200 in various ways. The feedback may result in the system selecting multiple further pre-generated video clips from the library. For example, if the viewer indicates by their feedback that a pre-generated clip comprising an exercise was too difficult, then the already selected or queued-up next pre-generated clip may be determined to also be too difficult. Thus, the library may be sampled for another more suitable clip based on the viewer feedback. The feedback may be received and cause the library to be sampled one or more further times during playout of the current personalised video stream. It should be understood that if no viewer feedback is received, or the received viewer feedback has no effect on the suitability of already selected video clips, then the library may not be further sampled.

The viewer feedback may further result in a change to a viewer characteristic. In this case future generated personalised video streams may also take into account the viewer feedback. This may be for a limited amount of time or until the same characteristic is determined to have changed again.

There may be a buffer period between playout and populating the scripted template in order to select the next pre-generated video clip. The scripted template may be populated based on viewer feedback. For example, a buffer period may be used if the selection of the next clip is based on viewer feedback on the previous one or more clips. The buffer period may also be used to allow for the pre-generated video clip content to be called from the relevant storage location and delivered to the viewer.

The generated personalised video stream may then be transmitted to the viewer or to multiple viewers having the same characteristics.

The video input to the system for the scripted template may be a single video stream (live or pre-recorded as mentioned above), streamed in a suitable format. For example, the format may be Secure, Reliable, Transport, SRT, or Real-Time Messaging Protocol, RTMP. This content may be captured at a professional video studio with camera, encoder hardware, and high bandwidth internet connection. However, the same content could be captured from a consumer-grade system, for example a laptop or a mobile phone. The scripted template may be one of a set of live videos. e.g the viewer may have the option to select which live presenter they prefer. Alternatively, the system may select for them. The system will then select to populate that scripted template from the set of pre-generated content options.

As mentioned above, the system 200 may have a database of viewers (e.g. as profiles) and characteristics about them. There may be multiple possible sources of viewer characteristics. Some characteristics may be gathered during an onboarding process, e.g. with a mobile or web application. Some characteristics may be knowledge of previous user behaviour or viewing history. Some characteristics may be based on feedback or interactions during viewing sessions. Other examples of viewer characteristics which may be used are: sub-categorisations of health conditions, risk stratification for any clinically relevant variable (e.g. risk of X complication), medication history (current and past), other medical history/existing conditions, emotional state e.g. anxiety level specific to the condition in question, occupational status—both whether they work but also what type of work they do, location, language, reported or observed preferences—for example music style, instructor style etc., key or relevant dates—for example if a rehabilitation programme for joint replacement was being provided then then a planned operation date could be a key characteristic with which to drive treatment content selection, hobbies and existing sports interest—for example it may be desirable to deliver separate advice to someone who says they usually go running vs someone who usually cycles vs someone who doesn't exercise, patient specific free text type information that may be incorporated into audio content—possibly with generative audio. For example, if a patient's motivation, e.g. I want my pain to get better so that I can push my child on the swing, then that characteristic could be used to select content.

The system 200 may comprise a method to generate sequences of pre-generated video clips for different viewers. The selection may be based on viewer characteristics or video metadata. The sequence generation may be via simple statistical models like a decision tree or more complex machine learning methods such as transformer networks, recurrent neural networks, and other sequence models. Viewers may be clustered into groups with similar but not identical characteristics to reduce the number of different personalised video stream sequences.

The system may combine the input scripted template stream with pre-generated clips in other ways than the continuous overlay described above. That is, where video frames with transparent backgrounds are merged into a single frame. For example, other ways of combining content include temporal—where videos are shown one at a time, or spatial—where video frames are shrunk and shown side-by-side.

The combining of the scripted template and the selected clips could be done before upload to the cloud—i.e. on local hardware, or in the cloud, or on a user device—i.e. after upload to the cloud.

Combination in the cloud of the scripted template (which may be in the form of a primary video feed), and the pre-generated video clips (which may be in the form of pre-stored video elements), can scale horizontally with a tree structure. A fanout server can be arranged to receive the upload and distribute it to mixer servers. That is, a fanout server may be arranged to receive the primary video feed and replicate the primary video feed to form a plurality of secondary video feeds. Each fanout server may be implemented by dedicated hardware. Mixer servers may then be used to combine the input stream with pre-recorded video. That is, there may be a plurality of mixers, arranged to receive a respective one of the secondary video streams, and determine a plurality of combinations of that secondary video stream with selected ones of the pre-stored video elements. The plurality of mixers may implement each of those combinations by combining the secondary stream with the selected pre-stored elements to form a respective output stream, and output the output streams for playout by viewers. Each mixer may be implemented by software executed by one or more processors. The pre-recorded video clips may be stored on fast drives or the memory of the mixer servers. The memory is, in any case, part of the video creation system.

In an embodiment, the combining may be done on serverless Edge compute platforms to be scalable without the burden of infrastructure management. The distribution as described above ensures each viewer receives the correct stream comprising a combination of the video feed and video elements. The system may include an application programming interface, API, to provide viewer devices with authenticated video uniform resource identifiers, URIs. The video format may be chosen to minimise latency without compromising the quality (e.g. HLS, WebRTC, etc.).

The output video may be enhanced in other ways before delivery to the viewer. These may be visual enhancements which are added to the video feed or video elements. For example, a background or scene replacement tool may be used. This may be achieved using existing techniques involving sky matting, motion estimation, and sky image blending. Frame generation may be used to smooth transitions between pre-generated video elements. Examples of this are IFRNet or FeatureFlow. In addition to these enhancements, blending lighting and audio to increase coherence of the video stream & pre-generated video elements can also be used to improve the final output video.

Viewers may interact with the system while watching to provide feedback, as described above. Their interactions may be received and processed in several ways. For example, speech-to-text—where prompting the viewer to respond verbally to questions or prompts is delivered by a live presenter and the audio response may be processed to turn it into text. The processing of the audio response may be carried out on a device of the user or in the cloud. Additionally or alternatively, questions with response buttons may be displayed on the viewer's device. The button selected by the viewer in response to the displayed question may then be processed as needed and fed back. Additionally or alternatively, data from a wearable device such as a smartwatch or fitness tracker may be utilised. The data may be filtered and processed on a device of the user or received at a server of the system and processed accordingly. Additionally or alternatively, a camera on a device in the vicinity of the viewer may provide visual feedback. For example, non-verbal communication may be gathered and processed such as sign language, nodding or shaking of the head, and other non-verbal indications of a response or sentiment.

There is therefore provided a video creation system as described above. The system is capable of receiving requests from viewers to view an output stream. The system comprises a management entity. The management entity may be configured to determine the number of requests for output streams and in dependence on that determination determine a number of mixers. In dependence on the determined number of mixers, the management entity may instantiate or terminate one or more instances of the mixers.

There is also provided a method for providing customised content to viewers. The method comprising receiving viewer information specific to each of a plurality of viewers. For example, a user profile or user feedback. The method also comprising storing a series of content elements, each content element being a video clip or a definition thereof. The method further comprising assigning one or more of a plurality of content type categories to each of the content elements, defining a program schedule comprising a series of content type categories, capturing by means of a video camera an input video stream; and executing program code on one more processors to select, for each of the viewers, a series of content elements of the categories defined in the program schedule, the content elements being selected in dependence on the viewer information of the respective viewer. There is formed, for each of the viewers, an output video stream by combining the input video stream with the selected series of content elements.

The program schedule may define a time for each of the content type categories of the series. The method may then comprise executing the program code to combine the input video stream with content elements of the respective categories at the respective times.

The steps of selecting and forming may be performed contemporaneously with the step of capturing. The video stream may comprise video of a presenter introducing content elements of the program schedule. At least one of the content elements may be a definition of a video clip. The method may thus comprise executing the program code to venerate the video clip according to the definition.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method of generating and playing out video content, the method comprising:
receiving one or more characteristics of a viewer;
selecting a plurality of video clips by sampling a library of pre-generated video clips based on the one or more characteristics; and
generating a personalised video stream by populating a scripted template with the selected plurality of video clips, wherein the method comprises sampling the library of pre-generated video clips one or more further times during the generating of the personalised video stream based on viewer feedback.

2. A method of generating and playing out video content, the method comprising:
receiving one or more characteristics of a viewer;
selecting a plurality of video clips by sampling a library of pre-generated video clips based on the one or more characteristics; and
generating a personalised video stream by populating a live scripted template with the selected plurality of video clips.

3. The method of claim 1 or 2, wherein the characteristics of the viewer comprise a medical condition or ailment.

4. The method of any preceding claim, wherein the pre-generated video clips are one or more of instructional videos comprising one or more tasks to be performed by the viewer or educational videos.

5. The method of claim 4, wherein the viewer feedback indicates a level of difficulty of the one or more tasks in one or more of the selected video clips already viewed.

6. The method of claim 4 or 5, wherein the viewer feedback comprises rating on a scale the difficulty of the one or more tasks in one or more of the selected video clips already viewed.

7. The method of any of claims 4 to 6, wherein the viewer feedback comprises detecting via a camera directed at the viewer that the viewer is unstable whilst performing one or more of the tasks in one or more of the selected video clips.

8. The method of any of claims 4 to 7, wherein the viewer feedback comprises detecting via a microphone of a device in the vicinity of the viewer that the viewer is in pain or struggling whilst performing one or more of the tasks in one or more of the selected video clips.

9. The method of any preceding claim, wherein the scripted template comprises multiple content forks populated by alternative video clips in anticipation of one of a plurality of possible viewer feedback options.

10. The method of any of claims 4 to 9, wherein the tasks are any combination of one or more of stretches, exercises, or yoga poses.

11. The method of any preceding claim, wherein the characteristics of a viewer comprise any one or more of age, sex, weight, height, fitness level, pre-existing health condition, blood sugar level, stage of treatment.

12. The method of any preceding claim, wherein the method comprises arranging the selected plurality of video clips into one or more groups prior to populating the scripted template based on one or more viewer characteristics.

13. The method of any preceding claim, wherein the scripted template is captured live and populated in during playout of the personalised video stream to the viewer.

14. The method of any preceding claim, wherein the scripted template is a pre-generated video and populated during playout of the personalised video stream to the viewer.

15. The method of claim 14, wherein the scripted template is populated based on viewer feedback.

16. The method of any preceding claim, wherein the scripted template comprises a live host.

17. The method of any preceding claim, wherein the personalised video stream is transmitted to multiple viewers having the same characteristics.

18. The method of any preceding claim, wherein the method comprises capturing the live scripted template comprising a host in front of a background replacement screen, and where the scripted template is dimensioned such that one or more of the pre-generated video clips may be inserted in place of the background replacement screen to give the impression that the host is present within the same three-dimensional physical space as a subject of the one or more pre-generated video clips.

19. The method of any preceding claim, wherein the method comprises:
capturing the scripted template comprising a host in front of a background replacement screen;
recording the pre-generated video clips in front of a background replacement screen; and
overlaying both the scripted template and pre-generated video clips on a common background in place of the background replacement screen and dimensioned to give the impression that the host and the subject of the one or more pre-generated video clips are present within the same three-dimensional physical space.

20. The method of any preceding claim, wherein the scripted template comprises portions where the host cannot be seen to allow for insertion of one or more of the pre-generated video clips which comprise panning shots or zoomed perspectives.

21. The method of any preceding claim, wherein the pre-generated video clips and scripted template have complimentary production parameters such as sound level, aspect ratio, lighting level, lighting direction.

22. The method of any preceding claim, wherein the pre-generated video clips and scripted template are produced with flat lighting.

23. The method of any preceding claim, wherein the pre-generated video clips comprise a difficulty rating and the pre-generated video clips are selected from the video library based on their assigned difficulty rating and how many personalised video streams a viewer has previously viewed in relation to their condition or ailment.

24. The method of any preceding claim, wherein the method comprises post-generation processing of the personalised video stream to alter the production parameters of the scripted template or the selected video clips or both to match the production parameters of a common background.

25. The method of any preceding claim, wherein the pre-generated video clips may have multiple audio tracks selectable depending on viewer characteristics.

26. The method of claim 25, wherein viewer characteristics comprise one or more of how many personalised video streams that viewer has previously viewed containing the same video clip, the viewer's nationality, the viewer's chosen language.

27. The method of any preceding claim, wherein the method comprises generating additional frames for insertion between pre-generated video clips to smooth scene transitions within the generated personalised video stream.

28. A method for providing customised content to viewers, comprising:
receiving viewer information specific to each of a plurality of viewers;
storing a series of content elements, each content element being a video clip or a definition thereof;
assigning one or more of a plurality of content type categories to each of the content elements;
defining a program schedule comprising a series of content type categories;
capturing by means of a video camera an input video stream; and
executing program code on one more processors to select, for each of the viewers, a series of content elements of the categories defined in the program schedule, the content elements being selected in dependence on the viewer information of the respective viewer; and to form for each of the viewers an output video stream by combining the input video stream with the selected series of content elements.

29. A method as claimed in claim 28, wherein the program schedule defines a time for each of the content type categories of the series, and the method comprises executing the program code to combine the input video stream with content elements of the respective categories at the respective times.

30. A method as claimed in claim 28 or 29, wherein the steps of selecting and forming are performed contemporaneously with the step of capturing.

31. A method as claimed in any of claims 28 to 30, wherein the video stream comprises video of a presenter introducing content elements of the program schedule.

32. A method as claimed in any of claims 28 to 31, wherein at least one of the content elements is a definition of a video clip, and the method comprises executing the program code to venerate the video clip according to the definition.

33. A video creation system for forming a plurality of custom video feeds by combining one or more pre-stored video elements with a primary video feed, the system comprising:
a memory storing the pre-stored video elements;
a fanout server arranged to receive the primary video feed and replicate the primary video feed to form a plurality of secondary video feeds; and
a plurality of mixers, arranged to receive a respective one of the secondary video streams, determine a plurality of combinations of that secondary video stream with selected ones of the pre-stored video elements, implement each of those combinations by combining the secondary stream with the selected pre-stored elements to form a respective output stream, and output the output streams for playout by viewers.

34. A video creation system as claimed in claim 33, wherein each mixer is implemented by software executed by one or more processors.

35. A video creation system as claimed in claim 33 or 34, wherein each fanout server is implemented by dedicated hardware.

36. A video creation system as claimed in any of claims 33 to 35, wherein the system is capable of receiving requests from viewers to view an output stream and the system comprises a management entity, the management entity being configured to:
determine the number of requests for output streams;
in dependence on that determination determine a number of mixers; and
in dependence on the determined number of mixers, instantiate or terminate one or more instances of the mixers.
